(19) United States
(12) Patent Application Publication
(10) Pub. No.: US 2024/0052134 A1
(43) Pub. Date: Feb. 15, 2024

(54) STERILIZABLE AND REUSABLE ULTRAVIOLET-RESISTANT ELASTOMER COMPOSITES, FABRICATING METHODS, AND APPLICATIONS OF SAME

(71) Applicant: NORTHWESTERN UNIVERSITY, Evanston, IL (US)

(72) Inventors: Mark C. Hersam, Wilmette, IL (US); Lidia Kuo, Evanston, IL (US); Benjamin J. Luijten, Evanston, IL (US); Ana Carolina Mazarin de Moraes, Westmont, IL (US); Shay G. Wallace, Beavercreek, OH (US)

(21) Appl. No.: 18/229,231

(22) Filed: Aug. 2, 2023

Related U.S. Application Data
(60) Provisional application No. 63/397,425, filed on Aug. 12, 2022.

(51) Int. Cl. C08K 3/04; C08L 75/04; C08J 3/20; A41D 13/12

(52) U.S. Cl. CPC C08K 3/042; C08L 75/04; C08J 3/203; A41D 13/12; C08K 2201/011; C08L 2201/08; C08L 2312/00; C08J 2375/00; C08J 2401/28

(57) ABSTRACT

The invention relates to a sterilizable and reusable ultraviolet-resistant elastomer composites including an elastomeric matrix comprising at least one elastomer; and an UV-resistant additive incorporated into the elastomeric matrix. The ultraviolet-resistant elastomer composite remains mechanically robust over at least 150 sterilization cycles, enabling safe reuse following ultraviolet germicidal irradiation (UVGI). Beyond N95 masks, these UVGI-compatible ultraviolet-resistant elastomer composites have potential utility in other PPE applications to address the broader issue of single-use waste.

### CROSS-REFERENCE TO RELATED PATENT APPLICATION

This application claims priority to and the benefit of U.S. Provisional Application No. 63/397,425, filed Aug. 12, 2022, which is incorporated herein in its entirety by reference.

### STATEMENT AS TO RIGHTS UNDER FEDERALLY-SPONSORED RESEARCH

This invention was made with government support under DMR-2029058, DGE-1842165, CMMI-2037026 and DMR-1720139 awarded by the National Science Foundation. The government has certain rights in the invention.

### FIELD OF THE INVENTION

The present invention generally relates to material science, particularly to sterilizable and reusable ultraviolet-resistant elastomer composites, fabricating methods, and applications of the same.

### BACKGROUND OF THE INVENTION

The background description provided herein is to present the context of the invention generally. The subject matter discussed in the background of the invention section should not be assumed to be prior art merely due to its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

The initial stages of the COVID-19 pandemic led to a dramatic shortage of critical personal protective equipment (PPE), including N95 masks, which offer high levels of protection against aerosol-borne pathogens. As a result, many medical personnel were forced to reuse N95 masks, oftentimes without proper sterilization. Ultraviolet germicidal irradiation (UVGI), utilizing the ultraviolet-C (UV-C) portion of the electromagnetic spectrum (200-280 nm), is a widely used sterilization technique in medical settings that has been shown to be effective at disinfecting N95 mask filters due to strong UV-C absorption by microbial nucleic acids. However, UVGI is not recommended by N95 mask manufacturers, primarily due to degradation of the elastomeric head straps, which compromises an effective fit and hence decreases filtration efficacy. Although N95 masks are no longer in short supply, aging of N95 mask straps and seals can also influence fit and effectiveness, posing challenges to long-term stockpiling of N95 masks. Therefore, to be better prepared for future pandemics, it is of high urgency to develop elastomeric materials that are resistant to UVGI irradiation, enabling decontamination and reuse of N95 masks and related PPE.

Another significant issue surrounding single-use PPE is waste generation and subsequent environmental and health impacts. During the height of the COVID-19 pandemic, it is estimated that an astounding 129 billion face masks and 65 billion gloves were being disposed monthly around the globe. Safe reuse of PPE is the preferred strategy to decrease single-use waste compared to developing biodegradable materials, which have unknown long-term environmental impacts. Furthermore, viral particles can live on plastics, including biodegradable polymers, for up to three days, which implies that discarded PPE can be vectors for viral transmission. Consequently, the development of UVGI-resistant elastomers that enable the safe reuse of PPE is of high interest from a sustainability and health perspective.

Therefore, a heretofore unaddressed need exists in the art to address the aforementioned deficiencies and inadequacies.

### SUMMARY OF THE INVENTION

In one aspect, this invention relates to a composite, comprising an elastomeric matrix comprising at least one elastomer; and an UV-resistant additive incorporated into the elastomeric matrix.

In one embodiment, the at least one elastomer comprises polyurethane. Other similar substitutes include polyisoprene, polypropylene, and polybutadiene.

In one embodiment, the UV-resistant additive is adapted for absorbing UV light, thereby suppressing UV-induced degradation of the elastomeric matrix.

In one embodiment, the UV-resistant additive comprises graphene.

In one embodiment, the graphene comprises solution-exfoliated graphene.

In one embodiment, a concentration of the graphene is up to 2 wt % of the composite.

In one embodiment, the concentration of the graphene is 1 wt % of the composite.

In one embodiment, increasing the concentration of the graphene in the composite improves mechanical strength and toughness of the composite.

In one embodiment, the UV-resistant additive further comprises a cellulose polymer for providing a mechanical reinforcement to the elastomeric matrix.

In one embodiment, the cellulose polymer comprises ethyl cellulose (EC). Other similar substitutes include nitrocellulose and cellulose nanocrystals.

In one embodiment, the graphene/EC powder is adapted to increase Young's modulus, elongation at break, and toughness, with negligible changes following UV exposure.

In one embodiment, Raman spectroscopy signals for the characteristic graphene peaks comprise D, G, and 2D peaks at 1342 cm⁻¹, 1578 cm⁻¹, and 2700 cm⁻¹, respectively, which are consistent with that of the graphene/EC powder, suggesting that the graphene remain intact following the composite formulation.

In one embodiment, the D/G peak ratio remains less than 1 in the composite, which confirms a relatively low graphene defect density compared to other graphene-based elastomeric composites that employ highly defective graphene oxide or reduced graphene oxide.

In one embodiment, the composites remain mechanically robust over at least 150 sterilization cycles, enabling safe reuse following ultraviolet germicidal irradiation (UVGI).

In one embodiment, the composite is UV and weathering resistant.

In one embodiment, the composite is a free-standing composite.

In one embodiment, the composite is fabricated by in-situ polymerization.

In another aspect, the invention relates to personal protective equipment (PPE), comprising at least one component formed of the above disclosed composite.

In one embodiment, the at least one component is a mask strap, or a glove. Other similar forms of PPE include medical gowns, medical bouffant caps, and related protective coverings.

In yet another aspect, the invention relates to method of fabricating a composite, comprising providing an elastomeric matrix and an UV-resistant additive; and mechanically mixing the UV-resistant additive with the elastomeric matrix.

In one embodiment, the elastomeric matrix comprises an elastomer kit including a crosslinker and a mix of elastomer polyols.

In one embodiment, said mixing step comprises: mixing various amounts of the UV-resistant additive with the elastomer polyols by bath sonicating and subsequently using a centrifugal mixer to form a first mixture thereof; adding the crosslinker into the first mixture to form a second mixture in which a weight ratio of the crosslinker to the elastomer polyols is about 1:1; and curing the second mixture at room temperature to form the composite.

In one embodiment, the method further comprises thermally treating the composite at a temperature for a period of time to further improve mechanical properties.

In one embodiment, the temperature is in a range of about 50-100° C., and the period of time is in a range of about 5-12 hrs.

In one embodiment, the elastomer comprises polyurethane. Other similar substitutes include polyisoprene, polypropylene, and polybutadiene.

In one embodiment, the UV-resistant additive is adapted for absorbing UV light, thereby suppressing UV-induced degradation of the elastomeric matrix.

In one embodiment, the UV-resistant additive comprises graphene.

In one embodiment, the graphene comprises solution-exfoliated graphene.

In one embodiment, a concentration of the graphene is up to 2 wt % of the composite.

In one embodiment, the concentration of the graphene is 1 wt % of the composite.

In one embodiment, increasing the concentration of the graphene in the composite improves mechanical strength and toughness of the composite.

In one embodiment, the UV-resistant additive further comprises a cellulose polymer for providing a mechanical reinforcement to the elastomeric matrix.

In one embodiment, the cellulose polymer comprises ethyl cellulose (EC). Other similar substitutes include nitrocellulose and cellulose nanocrystals.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematically a Gr-PU composite according to embodiments of the invention. Panel a: Schematic of the composite graphene-polyurethane (Gr-PU) elastomer formulation and fabrication workflow. Panel b: Schematic of the Gr-PU composite where graphene nanosheets and ethyl cellulose (EC) reinforce the PU matrix. Panel c: Schematic of the Gr-PU composite being exposed to UV-C irradiation. Panel d: Raman signal of the Gr-PU composite samples with varying concentrations of graphene. The characteristic D, G, and 2D Raman peaks emerge as the graphene concentration is increased.

FIG. 2 shows characterization of a pristine PU sample. Panels a-b: Optical images of a pristine PU sample (panel a) before and (panel b) after 30 h of UV-C exposure, showing an evident visible color change. Panels c-d: SEM images of a pristine PU sample (panel c) before and (panel d) after 30 h of UV-C exposure (scale bar is 100 μm). Panels e-f: Laser confocal microscopy images of a pristine PU sample (panel e) before and (panel f) after 30 h of UV-C exposure (scale bar is 200 μm). Panel g: Roughness profile comparison of a pristine PU sample before and after 30 h of UV-C exposure, which reveals increased roughness and surface cracking following UV-C exposure.

FIG. 3 shows characterization of a Gr-PU composite according to embodiments of the invention. Panels a-b: Optical images of a 1 wt % Gr-PU (1-Gr-PU) sample (panel a) before and (panel b) after 30 h of UV-C exposure. Panels c-d: SEM images of a 1-Gr-PU sample (panel c) before and (panel d) after 30 h of UV-C exposure (scale bar is 100 μm). Panels e-f: Laser confocal microscopy images of a 1-Gr-PU sample (panel e) before and (panel f) after 30 h of UV-C exposure (scale bar is 200 μm). Panel g: Roughness profile comparison of a 1-Gr-PU sample before and after 30 h of UV-C exposure, which reveals increased roughness but no surface cracking following UV-C exposure.

FIG. 4 shows characterization of a Gr-PU composite according to embodiments of the invention. Panel a: Representative stress-strain curves of pristine PU before and after 30 h of UV-C exposure. Panel b: Representative stress-strain curves of the 1-Gr-PU composite before and after 30 h of UV-C exposure. Panel c: Young's modulus as a function of increasing graphene content, before and after 30 h of UV-C exposure. Panel d: Elongation at break as a function of increasing graphene content, before and after 30 h of UV-C exposure. Panel e: Toughness as a function of increasing graphene content, before and after 30 h of UV-C exposure.

FIG. 5 shows heat treatment comparison according to embodiments of the invention. Stress-strain curves of pristine polyurethane (PU), showing the effect of the 8 h heat treatment at 65° C. in a box furnace at ambient conditions. The Young's modulus, elongation at break, and toughness are all improved following the 8 h heat treatment.

FIG. 6 shows ethyl cellulose and UV exposure according to embodiments of the invention. Panel a: Optical micrograph of a PU/ethyl cellulose (EC) elastomer composite before UV exposure. The sample was made in a similar way to the graphene composites, substituting 0.2 wt % EC in place of the graphene/EC powders. The scale bar is 50 μm. Panel b: The PU/EC sample after 4 h of UV exposure, showing evident crack growth and confirming the role of graphene in suppressing UV degradation. The scale bar is 50 μm.

FIG. 7 shows graphene/EC Raman spectra according to embodiments of the invention. Raman characterization of the raw graphite precursor and the resulting graphene/EC powder prior to incorporation into the PU matrix. The characteristic D, G, and 2D peaks of the graphene/EC powder agree with those of the Gr-PU composites.

FIG. 8 shows surface morphology evolution according to embodiments of the invention. Panels a-d: Optical micrographs of a pristine PU sample (panel a) preceding UV-C exposure, (panel b) after 4 h of UV-C exposure, (panel c) after 20 h of UV-C exposure, and (panel d) after 30 h of UV-C exposure. Cracking is evident after 4 h of UV-C exposure, with cracks growing in concentration with increasing UV-C exposure. Panels e-h: Optical micrographs of a 0.5 wt % graphene-PU (0.5-Gr-PU) sample (panel e) preceding UV-C exposure, (panel f) after 4 h of UV-C exposure, (panel g) after 20 h of UV-C exposure, and (panel h) after 30 h of UV-C exposure. Surface roughness is evident after 4 h of UV-C exposure, but then the surface roughness undergoes relatively little change with increasing UV-C exposure. The scale bars are 50 μm for all of the images in this figure.

FIG. 9 shows UV-exposed cross-sectional SEM according to embodiments of the invention. Panel a: Cross-sectional scanning electron microscopy (SEM) image of a pristine PU sample following 30 h of UV-C exposure, showing a crack on the scale of tens of microns deep. Panel a: Cross-sectional SEM of a 1 wt % Gr-PU (1-Gr-PU) sample following 30 h of UV-C exposure. The scale bar in both images is 10 μm.

FIG. 10 shows UV Exposure on 0.1-Gr-PU and 0.5-Gr-PU according to embodiments of the invention. Panels a-b: Confocal laser microscopy images of a 0.1 wt % Gr-PU (0.1-Gr-PU) sample (panel a) before and (panel b) after 30 h of UV-C exposure. The scale bar is 150 μm. Panel c: Corresponding roughness profile for the 0.1-Gr-PU sample. Panels d-e: Confocal laser microscopy images of a 0.5-Gr-PU sample (panel d) before and (panel e) after 30 h of UV-C exposure. The scale bar is 150 μm. Panel f: Corresponding roughness profile for the 0.5-Gr-PU sample. Panels g-h: SEM images of the 0.1-Gr-PU sample (panel g) before and (panel h) after 30 h of UV-C exposure, where cracking is evident. The scale bars in panels g-h are 100 μm and 50 μm, respectively. Panels i-j: SEM images of the 0.5-Gr-PU sample (panel i) before and (panel j) after 30 h of UV-C exposure, where the surface becomes rougher but no cracking is evident. The scale bars in panels i-j are both 100 μm.

FIG. 11 shows 3D confocal laser microscope scans according to embodiments of the invention. Corresponding 3D scans, accompanying the respective 2D scans in panels e-f of FIG. 2, panels e-f of FIG. 3, and panels a-b and d-e of FIG. 10. Panels a-b: Pristine PU before and after 30 h of UV-C exposure, respectively. Panels c-d: 0.1-Gr-PU sample before and after 30 h of UV-C exposure, respectively. Panels e-f: 0.5-Gr-PU sample before and after 30 h of UV-C exposure, respectively. Panels g-h: 1-Gr-PU sample before and after 30 h of UV-C exposure, respectively.

### DETAILED DESCRIPTION OF THE INVENTION

The invention will now be described more fully hereinafter with reference to the accompanying drawings, in which exemplary embodiments of the invention are shown. However, this invention may be embodied in many different forms and should not be construed as limited to the embodiments set forth herein. Rather, these embodiments are provided so that this specification will be thorough and complete and fully convey the invention's scope to those skilled in the art. Like reference numerals refer to like elements throughout.

The terms used in this specification generally have their ordinary meanings in the art, within the context of the invention, and in the specific context where each term is used. Certain terms used to describe the invention are discussed below, or elsewhere in the specification, to provide additional guidance to the practitioner regarding the description. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, or section without departing from the invention's teachings.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. Therefore, the exemplary terms “below” or “beneath” can encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Shortages of personal protective equipment (PPE) at the start of the COVID-19 pandemic caused medical workers to reuse medical supplies such as N95 masks. While ultraviolet germicidal irradiation (UVGI) is commonly used for sterilization, UVGI can also damage the elastomeric components of N95 masks, preventing effective fit and thus weakening filtration efficacy. Although PPE shortage is no longer an acute issue, the development of sterilizable and reusable UV-resistant elastomers remains of high interest from a long-term sustainability and health perspective.

Since the isolation of graphene from graphite, substantial research effort has been devoted to graphene-based materials due to their unique mechanical, thermal, and electronic properties that offer a wide range of applications. For instance, graphene has been used as an effective mechanical reinforcement in polymeric composites. Due to its zero band gap, graphene has also been shown to absorb UV radiation strongly, demonstrating promise as a UV-shielding additive or coating. For these reasons, graphene is a promising candidate to incorporate into elastomers to enable UVGI sterilization and reuse while improving overall mechanical properties, assuming that the graphene additive is produced using scalable and sustainable processing. Towards this end, we have previously reported the liquid-phase exfoliation of pristine graphene from graphite using ethyl cellulose (EC) stabilizers in ethanol. In addition to its proven scalability, this manufacturing method employs environmentally benign solvents and raw materials that can be produced from renewable bioderived sources, thus minimizing environment impact.

In this disclosure, graphene nanosheets, produced by scalable and sustainable exfoliation of graphite in ethanol using the polymer EC, are utilized as UV-resistant additives in polyurethane elastomer composites. By increasing the graphene loading up to 1 wt %, substantial UV protection is imparted by the graphene nanosheets, which strongly absorb UV light and hence suppress photo-induced degradation of the polyurethane matrix. Additionally, graphene/EC provides mechanical reinforcement, such as increasing Young's modulus, elongation at break, and toughness, with negligible changes following UV exposure. These graphene-polyurethane composites remain mechanically robust over at least 150 sterilization cycles, enabling safe reuse following UVGI. Beyond N95 masks, these UVGI-compatible graphene-polyurethane composites have potential utility in other PPE applications to address the broader issue of single-use waste.

In one aspect, this invention relates to a composite, comprising an elastomeric matrix comprising at least one elastomer; and an UV-resistant additive incorporated into the elastomeric matrix.

In one embodiment, the at least one elastomer comprises polyurethane. Other similar substitutes include polyisoprene, polypropylene, and polybutadiene.

In one embodiment, the UV-resistant additive is adapted for absorbing UV light, thereby suppressing UV-induced degradation of the elastomeric matrix.

In one embodiment, the UV-resistant additive comprises graphene.

In one embodiment, the graphene comprises solution-exfoliated graphene.

In one embodiment, a concentration of the graphene is up to 2 wt % of the composite.

In one embodiment, the concentration of the graphene is 1 wt % of the composite.

In one embodiment, increasing the concentration of the graphene in the composite improves mechanical strength and toughness of the composite.

In one embodiment, the UV-resistant additive further comprises a cellulose polymer for providing a mechanical reinforcement to the elastomeric matrix.

In one embodiment, the cellulose polymer comprises ethyl cellulose (EC). Other similar substitutes include nitrocellulose and cellulose nanocrystals.

In one embodiment, the graphene/EC powder is adapted to increase Young's modulus, elongation at break, and toughness, with negligible changes following UV exposure.

In one embodiment, Raman spectroscopy signals for the characteristic graphene peaks comprise D, G, and 2D peaks at 1342 cm⁻¹, 1578 cm⁻¹, and 2700 cm⁻¹, respectively, which are consistent with that of the graphene/EC powder, suggesting that the graphene remain intact following the composite formulation.

In one embodiment, the D/G peak ratio remains less than 1 in the composite, which confirms a relatively low graphene defect density compared to other graphene-based elastomeric composites that employ highly defective graphene oxide or reduced graphene oxide.

In one embodiment, the composites remain mechanically robust over at least 150 sterilization cycles, enabling safe reuse following ultraviolet germicidal irradiation (UVGI).

In one embodiment, the composite is UV and weathering resistant.

In one embodiment, the composite is a free-standing composite.

In one embodiment, the composite is fabricated by in-situ polymerization.

In another aspect, the invention relates to personal protective equipment (PPE), comprising at least one component formed of the above disclosed composite.

In one embodiment, the at least one component is a mask strap, or a glove. Other similar forms of PPE include medical gowns, medical bouffant caps, and related protective coverings.

In yet another aspect, the invention relates to method of fabricating a composite, comprising providing an elastomeric matrix and an UV-resistant additive; and mechanically mixing the UV-resistant additive with the elastomeric matrix.

In one embodiment, the elastomeric matrix comprises an elastomer kit including a crosslinker and a mix of elastomer polyols.

In one embodiment, said mixing step comprises: mixing various amounts of the UV-resistant additive with the elastomer polyols by bath sonicating and subsequently using a centrifugal mixer to form a first mixture thereof; adding the crosslinker into the first mixture to form a second mixture in which a weight ratio of the crosslinker to the elastomer polyols is about 1:1; and curing the second mixture at room temperature to form the composite.

In one embodiment, the method further comprises thermally treating the composite at a temperature for a period of time to further improve mechanical properties.

In one embodiment, the temperature is in a range of about 50-100° C., and the period of time is in a range of about 5-12 hrs.

In one embodiment, the elastomer comprises polyurethane. Other similar substitutes include polyisoprene, polypropylene, and polybutadiene.

In one embodiment, the UV-resistant additive is adapted for absorbing UV light, thereby suppressing UV-induced degradation of the elastomeric matrix.

In one embodiment, the UV-resistant additive comprises graphene.

In one embodiment, the graphene comprises solution-exfoliated graphene.

In one embodiment, a concentration of the graphene is up to 2 wt % of the composite.

In one embodiment, the concentration of the graphene is 1 wt % of the composite.

In one embodiment, increasing the concentration of the graphene in the composite improves mechanical strength and toughness of the composite.

In one embodiment, the UV-resistant additive further comprises a cellulose polymer for providing a mechanical reinforcement to the elastomeric matrix.

In one embodiment, the cellulose polymer comprises ethyl cellulose (EC). Other similar substitutes include nitrocellulose and cellulose nanocrystals.

While primarily designed with sterilizable and reusable PPE in mind, the graphene/EC composites introduced here may also find uses in other elastomeric applications such as medical equipment, textiles and reinforcement in cyclic wear, particularly in outdoor and related contexts where UV irradiation is unavoidable. One example is automotive tires, where graphene/EC can potentially improve mechanical properties and enable UV protection, enabling longer tire life and hence waste reduction through less frequent replacement.

Among other things, the invention provides at least the following advantages.

Graphene/EC powders can be produced in a scalable and sustainable manner, as previously demonstrated by the Hersam Laboratory. Scalable production of graphene is key to industrial-scale manufacturing of graphene-elastomer composites for a variety of applications including but not limited to PPE. Here, EC not only acts as a stabilizer for exfoliating graphene sheets and obtaining a high graphene yield, but also as a mechanical reinforcement to the polyurethane matrix. EC further improves mixability of graphene in the elastomer matrix, a key factor in enabling enhanced mechanical properties.

Only relatively low amounts of graphene/EC are necessary to obtain significant improvement in mechanical properties compared to pristine polyurethane. Graphene/EC powders can be mixed uniformly with the elastomer matrix, yielding a free-standing composite elastomer, thus overcoming a roadblock to commercializing graphene-polymer composites. At 1 wt % graphene/EC loading, enhancements in Young's Modulus, toughness, and elongation at break are observed, and these improvements are sustained after at least 150 UVGI sterilization cycles. Without graphene/EC addition, pristine polyurethane experiences significant microstructural damage after UV exposure, leading to degradation of mechanical properties.

Improved mechanical properties and imparted robust UV-stability by graphene/EC addition to the elastomer matrix have further implications in waste reduction beyond single-use PPE. Targeting the challenge of single-use waste, graphene/EC elastomer composites can be extended to sterilizable and reusable medical equipment and wearable sensors. A broader application is life cycle extension of elastomeric materials that undergo cyclic wear in outdoor contexts, where UV exposure in unavoidable, such as textiles and automotive tires.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example

### Sterilizable and Reusable UV-Resistant Graphene-Polyurethane Elastomer Composites

Shortages of personal protective equipment (PPE) at the start of the COVID-19 pandemic caused medical workers to reuse medical supplies such as N95 masks. While ultraviolet germicidal irradiation (UVGI) is commonly used for sterilization, UVGI can also damage the elastomeric components of N95 masks, preventing effective fit and thus weakening filtration efficacy. Although PPE shortage is no longer an acute issue, the development of sterilizable and reusable UV-resistant elastomers remains of high interest from a long-term sustainability and health perspective.

Since the isolation of graphene from graphite, substantial research effort has been devoted to graphene-based materials due to their unique mechanical, thermal, and electronic properties that offer a wide range of applications. For instance, graphene has been used as an effective mechanical reinforcement in polymeric composites. Due to its zero band gap, graphene has also been shown to absorb UV radiation strongly, demonstrating promise as a UV-shielding additive or coating. For these reasons, graphene is a promising candidate to incorporate into elastomers to enable UVGI sterilization and reuse while improving overall mechanical properties, assuming that the graphene additive is produced using scalable and sustainable processing. Towards this end, we have previously reported the liquid-phase exfoliation of pristine graphene from graphite using ethyl cellulose (EC) stabilizers in ethanol. In addition to its proven scalability, this manufacturing method employs environmentally benign solvents and raw materials that can be produced from renewable bioderived sources, thus minimizing environment impact.

In this exemplary example, graphene nanosheets are utilized as UV-resistant additives in polyurethane elastomer composites. By increasing the graphene loading up to 1 wt %, substantial UV protection is imparted by the graphene nanosheets, which strongly absorb UV light and hence suppress photo-induced degradation of the polyurethane matrix. Additionally, graphene/EC provides mechanical reinforcement, such as increasing Young's modulus, elongation at break, and toughness, with negligible changes following UV exposure. These graphene-polyurethane composites remain mechanically robust over at least 150 sterilization cycles, enabling safe reuse following UVGI. Beyond N95 masks, these UVGI-compatible graphene-polyurethane composites have potential utility in other PPE applications to address the broader issue of single-use waste.

Specifically, we report the formulation and testing of free-standing composites of polyurethane (PU) and graphene/EC. PU was chosen as a prototypical elastomeric matrix due to its widespread use in many applications, including N95 mask straps. While graphene and graphene-based PU composites have been studied previously for UV and weathering resistance, these previous reports have focused on graphene coatings rather than free-standing composites, only explored UV wavelengths outside the UV-C spectrum, and/or did not perform mechanical testing. In contrast, our free-standing composites are optimized to preserve their elastomeric mechanical properties following simulated UVGI conditions. In particular, we show that, unlike pristine PU that is microstructurally damaged and degrades in mechanical quality after prolonged UV-C exposure, the graphene-polyurethane (Gr-PU) composites prevent UV-induced cracking and thus preserve mechanical properties. As an added benefit, the graphene/EC additive serves as a mechanical reinforcement such that the Gr-PU composites after 30 h of UV-C exposure still possess superior mechanical properties compared to PU before any UV-C exposure. In this manner, Gr-PU composite mask straps enable sterilization and reuse of N95 masks for at least 150 UVGI decontamination cycles. Since elastomers are used in many other PPE applications (e.g., safety gloves), these UVGI-compatible Gr-PU composites can be widely utilized in other PPE contexts, thus providing an effective means of minimizing disposable PPE waste.

### Materials and Methods

Graphene/EC Powder Preparation: The graphene/EC powder was prepared by adding graphite, EC, and ethanol in a 30:1:20 weight ratio and shear mixing the dispersion for 23 hours using an inline mixer (200 L, Silverson). Graphene/EC powders were obtained after centrifuging the resulting dispersion at 6500 RPM for 30 min, flocculating with a 40 mg/mL concentration of aqueous NaCl, rinsing with deionized water, and drying with an infrared lamp. Prior to incorporation into Gr-PU composites, the graphene powders were ground with a mortar and pestle. The final graphene/EC powder contains 34 wt % graphene.

Gr-PU Composite Preparation: The aforementioned graphene/EC powder was mechanically mixed with a commercially available polyurethane kit, comprised of Part A, the crosslinker, and Part B, a mix of polyurethane polyols (VytaFlex 20, Smooth-On). Various amounts of the graphene/EC powder were measured and mixed with Part B, which is the less viscous component, by bath sonicating until the graphene/EC powder was well dispersed and subsequently using a planetary centrifugal mixer (ARE-310, Thinky) with zirconia milling beads for 20 min. The 20 min cycle included 3 min steps, each followed by a 1 min pause for defoaming, which was repeated 5 times. The 5 steps varied in revolution speed as follows: 800, 1200, 1600, 2000, and 2000 rpm. Part A was then added to the well-mixed graphene/Part B so that the weight ratio of Part A to Part B was 1:1. The total weight of the sample was tuned according to the size of the molds such that the final thicknesses of the composites were about 0.75-1.0 mm. The combined components were mixed in the planetary centrifugal mixer for an additional 3 min at 2000 rpm. Subsequently, the final composite formulation was poured into the Teflon mold, degassed in a vacuum oven for 2 min to remove trapped air bubbles, and set aside to cure overnight for about 16 h at room temperature. Following the overnight cure, the composite was annealed at 65° C. in a box furnace for 8 h to further improve mechanical properties. Similarly, pristine polyurethane control samples were fabricated by hand-mixing a 1:1 weight ratio of Part A and Part B, placed in a Teflon mold, degassed, cured overnight at room temperature, and thermally treated at 65° C. for 8 h.

UVGI Exposure: Samples were placed in a reflective UV-C chamber (BioShift), equipped with four 20 W lamps at 254 nm. To ensure UV-C exposure on all sides, the samples were suspended inside the chamber at a distance of 3 in from the closest UV-C lamp. UV-C exposure was performed in 1 h increments up to a maximum of 30 h of total exposure time, which is estimated to be equivalent to 150 UVGI sterilization cycles based on literature precedent. It should be noted that the UV-C chamber manufacturer specifies that that >99.99% of bacteria and viruses on surfaces are killed within 5 min, so 150 UVGI sterilization cycles is likely to be a conservative underestimate.

Characterization: The surface morphology of the elastomer samples was characterized by a 3D laser confocal scanning microscope (LEXT OLS5000, Olympus), and the resulting scans were analyzed using the LEXT software from the manufacturer. SEM images were obtained on a Hitachi SU8030 scanning electron microscope. To characterize the chemical content of the elastomers, Raman spectroscopy (Horiba) was performed using a 532 nm laser. Mechanical data was obtained from tensile tests using an MTS Criterion Series 40 instrument.

### Results and Discussion

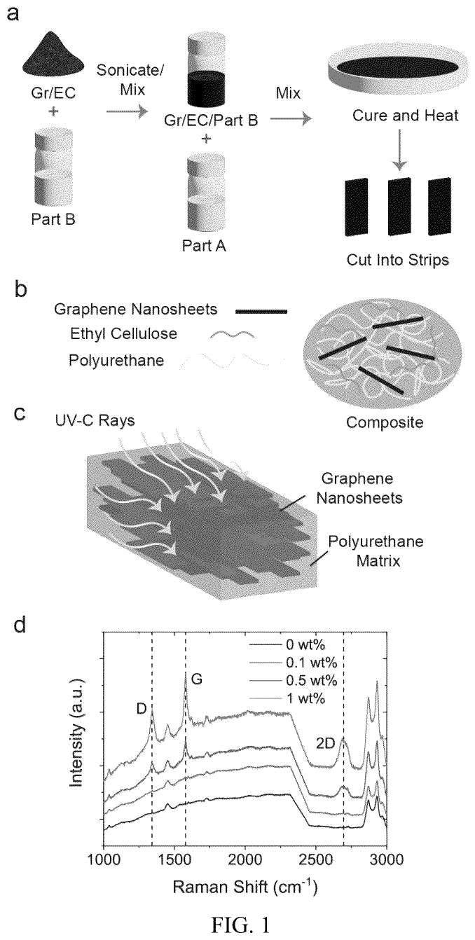

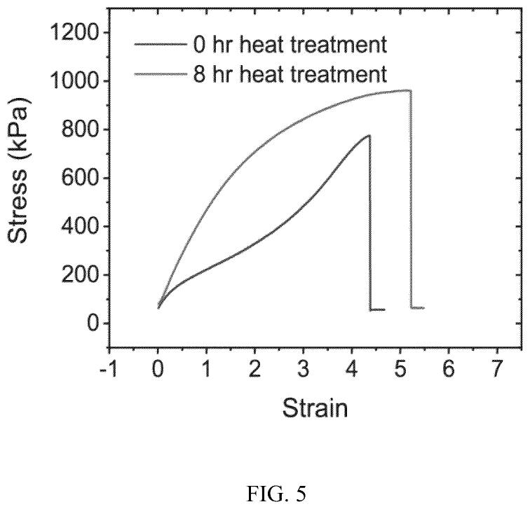

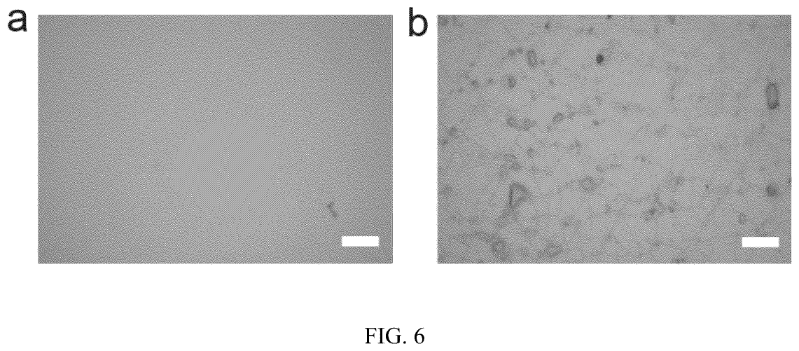

The Gr-PU composites were fabricated by in-situ polymerization. Specifically, varying concentrations of graphene/EC powders (from 0 to 1 wt %) were mechanically mixed with commercially available polyurethane polyols, VytaFlex 20 Part B, and a crosslinker, VytaFlex Part A (panel a of FIG. 1). The resulting composites were cured overnight in a Teflon mold and subsequently heat treated to further improve mechanical properties (FIG. 5). Lastly, the Gr-PU composites were cut into strips for testing. Control samples of unmodified PU were fabricated in a similar manner by mixing Part A and Part B without graphene or EC. While EC is often removed from the graphene powders by annealing for electronic applications, here we exploit the known ability of EC to act as a mechanical reinforcement to PU in order to supplement the composite mechanical properties (panel b of FIG. 1). However, EC itself does not impart UV resistance since the EC-only modified composites reveal UV-induced microstructural damage (FIG. 6), confirming that the graphene nanosheets act as the UV-absorbing material to protect the PU matrix (panel c of FIG. 1).

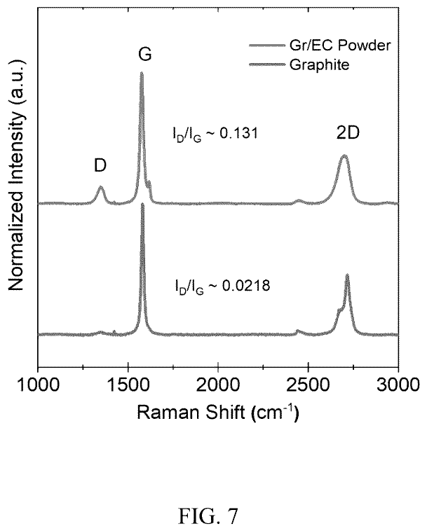

The Gr-PU composites possess a homogenously black appearance after adding as little as 0.1 wt % graphene (0.1-Gr-PU), which indicates that the graphene is well distributed throughout the PU matrix. As the graphene concentration of the Gr-PU composite is increased, the Raman spectroscopy signal for the characteristic graphene peaks commensurately becomes stronger, confirming successful incorporation of graphene into the PU matrix (panel d of FIG. 1). The D, G, and 2D peaks at 1342 cm⁻¹, 1578 cm⁻¹, and 2700 cm⁻¹, respectively, are particularly evident above 0.5 wt % graphene. These Raman peak positions are consistent with the starting graphene/EC powder (FIG. 7), suggesting that the graphene nanosheets remain intact following the Gr-PU composite formulation. Moreover, the D/G peak ratio remains less than 1 in the Gr-PU composite, which confirms a relatively low graphene defect density compared to other graphene-based elastomeric composites that employ highly defective graphene oxide or reduced graphene oxide.

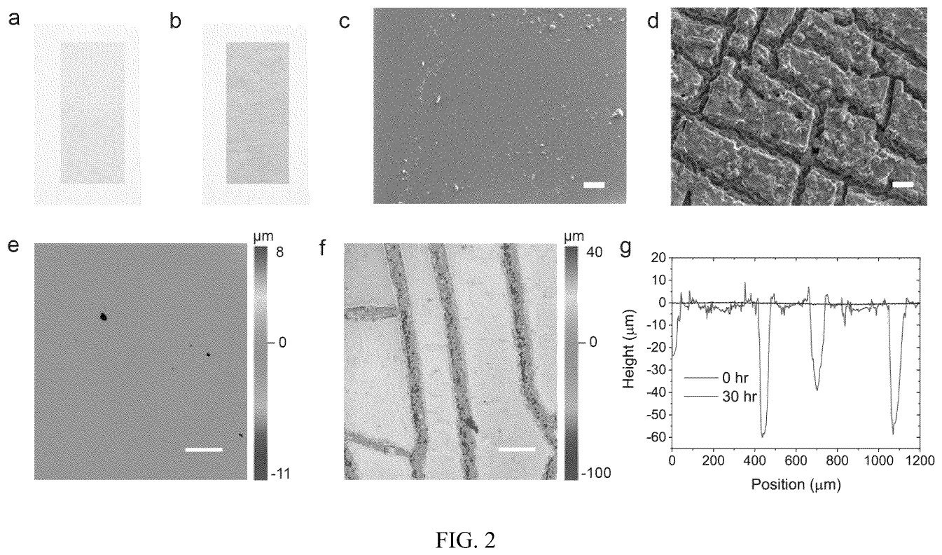

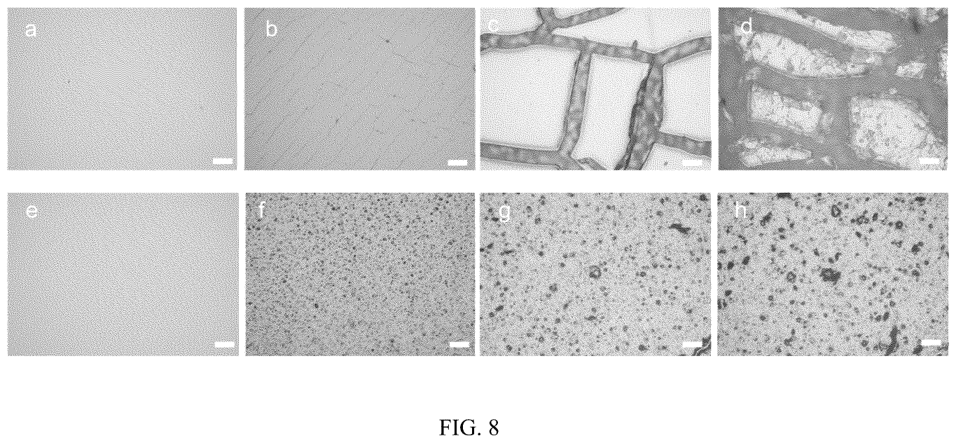

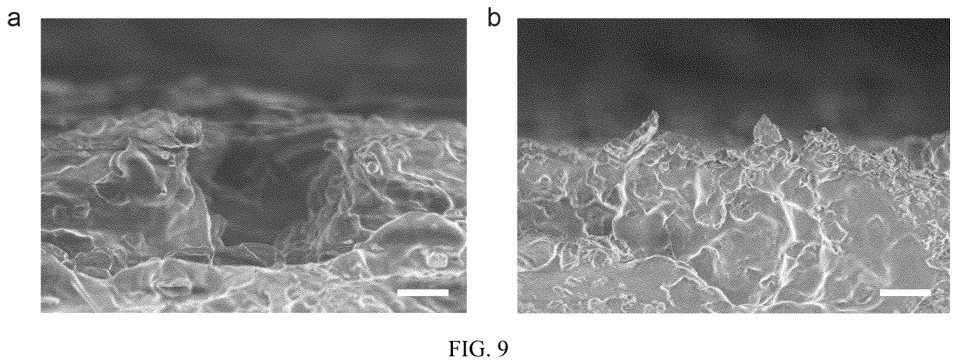

To test for compatibility with UVGI sterilization, the pristine PU control and Gr-PU composite samples were exposed to repeated UV-C cycles (254 nm), totaling 30 h or the equivalent of 150 sterilization cycles. Overall, UV-C irradiation leads to substantial microstructural damage in the pristine PU samples. In particular, after 30 h of UV-C exposure, the pristine PU sample visually appears yellow, compared to its original pink-transparent hue (panels a-b of FIG. 2). This evident color change is indicative of photooxidation that is caused by the UV-induced scission of the —CH₂— chains. Prior to UV-C exposure, the pristine PU samples are relatively smooth at the surface, with minimal topographic features observed with scanning electron microscopy (SEM) (panel c of FIG. 2). On the other hand, significant cracking is observed following 30 h of UV-C exposure in addition to surface roughening (panel d of FIG. 2). Cracks form on the pristine PU surface after as little as 4 h of UV-C exposure, which then grow in size, depth, and concentration as the UV-C exposure time increases (panels a-d of FIG. 8). These changes in surface features are further corroborated by confocal laser microscopy (panels e-f of FIG. 2), where the corresponding line profiles indicate cracks that are 20-60 μm deep and ˜50 μm wide following 30 h of UV-C exposure (panel g of FIG. 2). Cross-sectional SEM of the PU sample following 30 h of UV-C exposure further corroborates the depth and width of these surface cracks (panel a of FIG. 9).

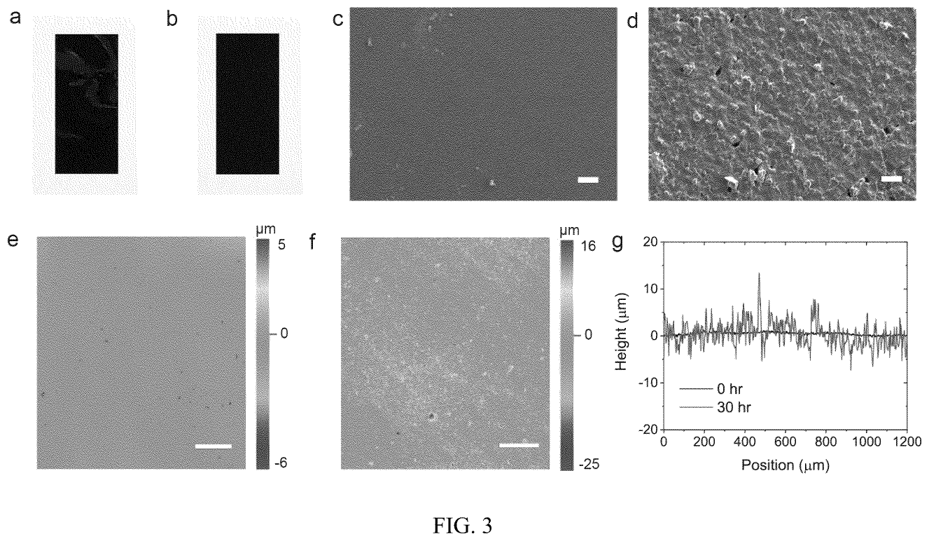

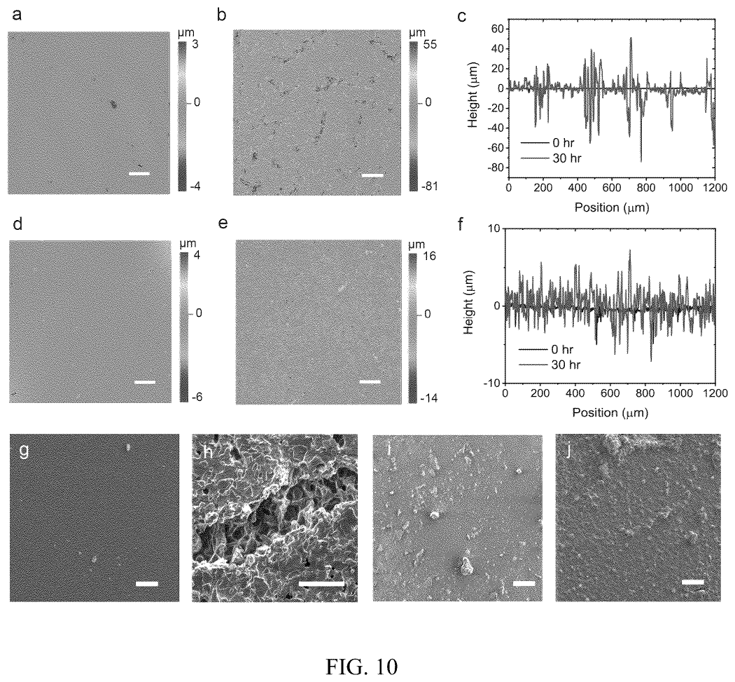

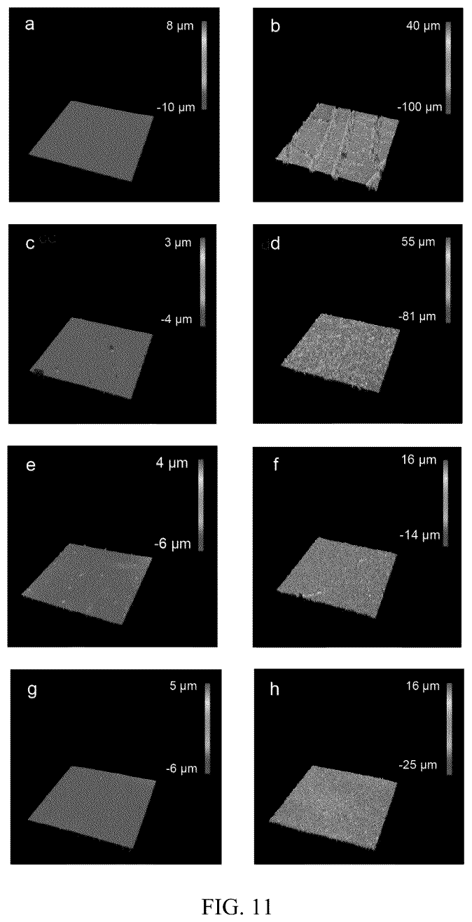

Unlike the pristine PU control, the 1-Gr-PU sample withstands 30 h of UV-C exposure without cracking. Visually, the 1-Gr-PU composite appears black in color before and after UV-C exposure (panels a-b of FIG. 3). The main difference is that the 1-Gr-PU composite loses its gloss after UV-C exposure, which can be attributed to surface roughening. An increase in surface roughness is confirmed by SEM and confocal laser microscopy (panels c-g of FIG. 3, panel b of FIG. 9). Similar to the pristine PU sample, the 1-Gr-PU sample is relatively smooth prior to UV-C exposure, which indicates that the addition of graphene does not significantly alter the surface morphology of the PU matrix, but does successfully suppress cracking and photoinduced —CH₂— chain scission upon UV-C irradiation. Following the initial surface roughening, the surface roughness of the 1-Gr-PU composite then remains relatively consistent with increasing UV-C exposure time in stark contrast to the pristine PU sample (panel e-h of FIG. 8). Analogous results are observed for the 0.5-Gr-PU composite, although some surface cracking is visible for the 0.1-Gr-PU elastomer after 30 h of UV-C exposure (FIGS. 10-11). Overall, a higher surface roughness value is observed for the 0.1-Gr-PU sample, whereas the surface roughness values for the 0.5-Gr-Pu and 1-Gr-PU samples are both about 5-fold lower (Table 1).

TABLE 1
Surface Roughness Comparison.

| Graphene Concentration | UV Exposure Time | Root Mean Square |
|---|---|---|
| (wt %) | (h) | Height (Sq) |
| 0 | 0 | 0.35 |
| 0 | 30 | 23.7 |
| 0.1 | 0 | 0.38 |
| 0.1 | 30 | 14.3 |
| 0.5 | 0 | 0.5 |
| 0.5 | 30 | 2.78 |
| 1 | 0 | 0.30 |
| 1 | 30 | 2.62 |

At each graphene concentration, the surface becomes rougher after 30 h of UV-C exposure, as corroborated by a measure of root mean square height (Sq), or the standard deviation of heights throughout the area of interest. Values were obtained from confocal laser microscopy 2D scans and calculated by the LEXT software. Initial Sq values before UV exposure are similar across the various concentrations. The Sq value is greatest for the 0 wt % graphene sample after 30 h of UV-C exposure, followed by the 0.1 wt % graphene sample after the same exposure time. Sq values for the 0.5 wt % and 1 wt % graphene samples are similar after UV exposure, indicating that 0.5 wt % graphene provides adequate protection against cracking.

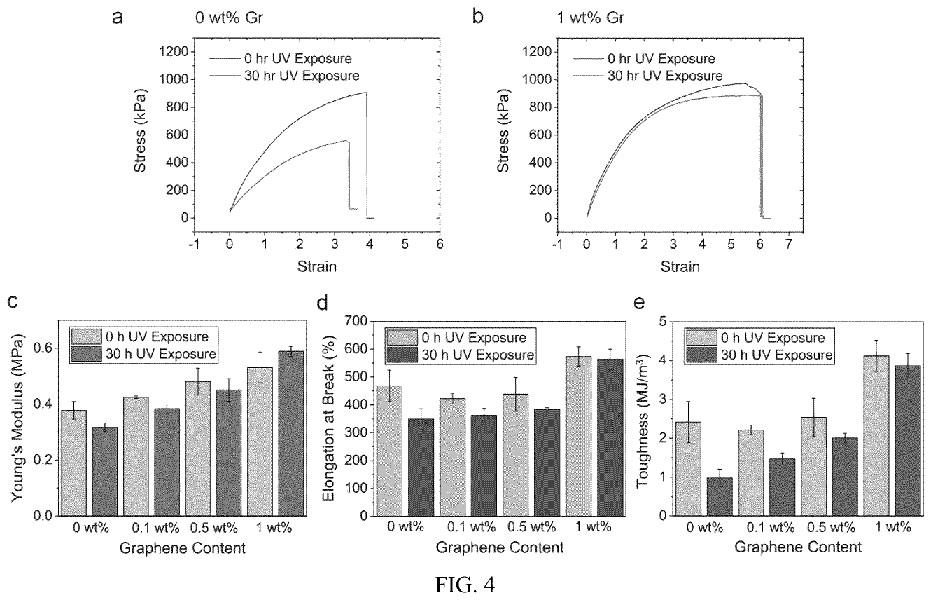

Improved surface morphology after UV-C exposure for the 1-Gr-PU composite is mirrored in its higher mechanical performance. Whereas tensile stress-strain curves indicate severe degradation in mechanical behavior for pristine PU after 30 h of UV-C degradation (panel a of FIG. 4), the tensile stress-strain curves for the 1-Gr-PU sample show that the mechanical properties are largely preserved even after extended UV-C irradiation (panel b of FIG. 4). Following UV-C degradation, pristine PU decreases in Young's modulus by 16% (0.38 to 0.32 MPa), elongation at break by 34% (468 to 349%), and toughness by 59% (2.42 to 0.98 MJ/m 3) (panels b-d of FIG. 4). This performance decrease can be attributed to UV-induced surface degradation. In these un-notched tensile specimens, fracture is dominated by the growth of macroscopic cracks from existing flaws in the material. The stress required to propagate a crack is strongly dependent on the flaw size (in this case, the surface crack size), with larger flaw sizes significantly reducing the stress required for fracture through stress concentration near the crack tip. As the size of the dominant flaws in the material are increased by UV-induced degradation of the surface, the stress required to propagate these cracks is decreased, resulting in reduced elongation at break and lower toughness. The degraded mechanical properties of pristine PU following UV-C irradiation is consistent with manufacturer warnings not to attempt UVGI sterilization of N95 masks.

Increasing graphene content in the Gr-PU composites incrementally improves mechanical strength, prior to any UV-C exposure, due to increased mechanical reinforcement by graphene and EC (panel c of FIG. 4). The 1-Gr-PU composite performs the best, exhibiting an increase in Young's modulus of 41% compared to the pristine elastomer (0.53 MPa compared to 0.38 MPa). At all graphene loadings, Gr-PU composites following 30 h of UV-C exposure show roughly equal or higher Young's moduli compared to the unexposed pristine PU sample. Although the Young's modulus slightly decreases following UV-C exposure for the 0.1-Gr-PU sample (9.7% average decline), the post-UV Young's modulus for the 0.1-Gr-PU sample is still comparable to the unexposed pristine PU sample. As a stark contrast to the pristine PU, the 1-Gr-PU composite preserves its Young's modulus following 30 h of UV-C exposure within standard error, implying negligible changes in mechanical strength after UV-C irradiation.

Elongation at break is also improved for the 1-Gr-PU composite by 22% (from 468% to 573%), with little change after 30 h of UV-C exposure (panel d of FIG. 4). In comparison, the 0.1-Gr-PU and 0.5-Gr-PU samples exhibit similar elongations at break before and after UV-C exposure to that of the pristine PU sample, showing a modest decrease after UV-C irradiation (about 19% average decrease in each case). This result indicates that elongation to failure is mostly unchanged until a sufficiently high graphene concentration is reached. However, beyond the optimal graphene loading, the marginal increase in elongation at break will become negative due to graphene agglomeration. The improved elongation at failure for the 1-Gr-PU sample can possibly be explained by a dilution effect, in which the volume fraction of the PU matrix declines and thus has a lower degree of cross-linking within the PU matrix. While a tradeoff between Young's modulus and elongation at break is commonly observed for polymer composites, the 1-Gr-PU sample exhibits a higher Young's modulus in addition to increased elongation at break.

Toughness is also improved with increasing graphene content (panel e of FIG. 4). Prior to UV-C exposure, the pristine PU, 0.1-Gr-PU, and 0.5-Gr-PU samples exhibit similar average toughnesses of about 2.5 MJ/m 3, whereas the 1-Gr-PU composite possesses the highest average toughness of 4.1 MJ/m 3, or a 70% increase compared to bare PU. The improved toughness of the 1-Gr-PU composite is reflective of the increased Young's modulus and increased elongation at break. After UV-C irradiation, toughness is incrementally preserved with increasing graphene content. Compared to a 59% average toughness reduction (2.42 MJ/m 3 to 0.98 MJ/m 3) for the pristine PU sample after UV exposure, the toughness of the 0.1-Gr-PU composite only decreases by 34% (2.2 MJ/m 3 to 1.5 MJ/m 3). This toughness reduction is essentially eliminated at higher graphene loadings, as the 0.5-Gr-PU and 1-Gr-PU composites exhibit toughness within standard error compared to their respective counterparts before UV-C exposure. The reduced degree of toughness preservation of the 0.1-Gr-PU sample, compared to the composites with higher graphene loading, can be attributed to the lack of full UV-C protection at 0.1 wt % graphene loading, as cracking can still be observed at this graphene concentration. Notably, the toughness of the 1-Gr-PU composite after 30 h of UV-C exposure even outperforms the pristine PU sample before UV-C exposure by 63% (3.9 MJ/m 3 compared to 2.4 MJ/m 3).

### CONCLUSION

In summary, UV-resistant Gr-PU elastomeric composites have been realized based on scalably and sustainably produced graphene/EC powders. Significant mechanical property improvements as well as UV-C resistance are imparted by the incorporation of graphene/EC powders such that the mechanical properties of the 1-Gr-PU sample after 30 h of UV-C exposure even outperforms bare PU preceding UV-C exposure. This improved performance can be attributed to the suppression of UV-induced surface crack formation in the Gr-PU composites in addition to mechanical reinforcement of the PU matrix by graphene/EC. Since 30 h of UV-C exposure is equivalent to 150 UVGI sterilization cycles, these Gr-PU composites enable significant reuse of N95 masks, thus providing a pathway to substantial reductions in single-use PPE waste. While primarily designed with sterilizable and reusable PPE in mind, the Gr-PU composites introduced here may also find uses in other elastomeric applications, particularly in outdoor and related contexts where UV irradiation is unavoidable.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described to explain the principles of the invention and their practical application to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Dugdale, C. M.; Walensky, R. P. Filtration Efficiency, Effectiveness, and Availability of N95 Face Masks for Covid-19 Prevention. JAMA Internal Medicine 2020, 180 (12), 1612, DOI: 10.1001/jamainternmed.2020.4218
[2]. Ramos, C. C. R.; Roque, J. L. A.; Sarmiento, D. B.; Suarez, L. E. G.; Sunio, J. T. P.; Tabungar, K. I. B.; Tengco, G. S. C.; Rio, P. C.; Hilario, A. L. Use of Ultraviolet-C in Environmental Sterilization in Hospitals: A Systematic Review on Efficacy and Safety. Int. J Health Sci. (Qassim) 2020, 14 (6), 52.
[3]. Centers for Disease Control and Prevention. Implementing Filtering Facepiece Respirator (FFR) Reuse, Including Reuse after Decontamination, When There Are Known Shortages of N95 Respirators. https://www.cdc.gov/coronavirus/2019-ncov/hcp/ppe-strategy/decontamination-reuse-respirators.html (accessed on Jul. 31, 2022).
[4]. Lin, T.-H.; Tseng, C.-C.; Huang, Y.-L.; Lin, H.-C.; Lai, C.-Y.; Lee, S.-A. Effectiveness of N95 Facepiece Respirators in Filtering Aerosol Following Storage and Sterilization. Aerosol and Air Quality Research 2020, 20 (4), 833-843, DOI: 10.4209/aaqr.2019.12.0620
[5]. Rottach, D. R.; Lei, Z. Stockpiled N95 Filtering Facepiece Respirator Polyisoprene Strap Performance. J Int. Soc. Respir. Prot. 2017, 34 (2), 69.
[6]. Xu, E. G.; Ren, Z. J. Preventing Masks from Becoming the next Plastic Problem. Frontiers of Environmental Science & Engineering 2021, 15 (6), DOI: 10.1007/s11783-021-1413-7
[7]. Prata, J. C.; Silva, A. L. P.; Walker, T. R.; Duarte, A. C.; Rocha-Santos, T. Covid-19 Pandemic Repercussions on the Use and Management of Plastics. Environmental Science & Technology 2020, 54 (13), 7760-7765, DOI: 10.1021/acs.est.0c02178
[8]. Geim, A. K.; Novoselov, K. S. The Rise of Graphene. Nature Materials 2007, 6 (3), 183-191, DOI: 10.1038/nmat1849
[9]. Papageorgiou, D. G.; Kinloch, I. A.; Young, R. J. Graphene/Elastomer Nanocomposites. Carbon 2015, 95, 460-484, DOI: 10.1016/j.carbon.2015.08.055
[10]. Lin, Y.; Liu, S.; Chen, S.; Wei, Y.; Dong, X.; Liu, L. A Highly Stretchable and Sensitive Strain Sensor Based on Graphene-Elastomer Composites with a Novel Double-Interconnected Network. Journal of Materials Chemistry C 2016, 4 (26), 6345-6352, DOI: 10.1039/C6TC01925K
[11]. Khan, U.; May, P.; O'Neill, A.; Coleman, J. N. Development of Stiff, Strong, Yet Tough Composites by the Addition of Solvent Exfoliated Graphene to Polyurethane. Carbon 2010, 48 (14), 4035-4041, DOI: 10.1016/j.carbon.2010.07.008
[12]. Fan, W.; Wang, J.; Zhang, Z.; Li, Z. Synergistic Enhancement of UV-Resistance and Electrical Conductivity of Waterborne Polyurethane Composite with Combination of Functionalized 2D Graphene Oxide and 1D Nanocellulose. Progress in Organic Coatings 2021, 151, 106017, DOI: 10.1016/j.porgcoat.2020.106017
[13]. Wan, C.; Jiao, Y.; Li, J. In Situ Deposition of Graphene Nanosheets on Wood Surface by One-Pot Hydrothermal Method for Enhanced UV-Resistant Ability. Applied Surface Science 2015, 347, 891-897, DOI: 10.1016/j.apsusc.2015.04.178
[14]. Seyed Shahabadi, S. I.; Kong, J.; Lu, X. Aqueous-Only, Green Route to Self-Healable, UV-Resistant, and Electrically Conductive Polyurethane/Graphene/Lignin Nanocomposite Coatings. ACS Sustainable Chemistry & Engineering 2017, 5 (4), 3148-3157, DOI: 10.1021/acssuschemeng.6b02941
[15]. Bramhecha, I.; Sheikh, J. Antibacterial and Waterproof Breathable Waterborne Polyurethane Functionalised by Graphene to Develop UV and Nir-Protective Cotton Fabric. Carbon Trends 2021, 4, 100067, DOI: 10.1016/j.cartre.2021.100067
[16]. Adak, B.; Joshi, M.; Butola, B. S. Polyurethane/Functionalized-Graphene Nanocomposite Films with Enhanced Weather Resistance and Gas Barrier Properties. Composites Part B: Engineering 2019, 176, 107303, DOI: 10.1016/j.compositesb.2019.107303
[17]. Murariu, A. C.; Macarie, L.; Crisan, L.; Pleu, N. Experimental Investigations of ALMG3 Components with Polyurethane and Graphene Oxide Nanosheets Composite Coatings, after Accelerated UV-Aging. Molecules 2021, 27 (1), 84, DOI: 10.3390/molecules27010084
[18]. Liang, Y. T.; Hersam, M. C. Highly Concentrated Graphene Solutions via Polymer Enhanced Solvent Exfoliation and Iterative Solvent Exchange. Journal of the American Chemical Society 2010, 132 (50), 17661-17663, DOI: 10.1021/ja107661g
[19]. Hyun, W. J.; Secor, E. B.; Hersam, M. C. White Paper: Printable Graphene Inks Stabilized with Cellulosic Polymers. MRS Bulletin 2018, 43 (10), 730-732, DOI: 10.1557/mrs.2018.241
[20]. Secor, E. B.; Prabhumirashi, P. L.; Puntambekar, K.; Geier, M. L.; Hersam, M. C. Inkjet Printing of High Conductivity, Flexible Graphene Patterns. The Journal of Physical Chemistry Letters 2013, 4 (8), 1347-1351, DOI: 10.1021/jz400644c
[21]. Armentano, I.; Barbanera, M.; Carota, E.; Crognale, S.; Marconi, M.; Rossi, S.; Rubino, G.; Scungio, M.; Taborri, J.; Calabrò, G. Polymer Materials for Respiratory Protection: Processing, End Use, and Testing Methods. ACS Applied Polymer Materials 2021, 3 (2), 531-548, DOI: 10.1021/acsapm.0c01151
[22]. Chen, P.-H.; Liao, H.-C.; Hsu, S.-H.; Chen, R.-S.; Wu, M.-C.; Yang, Y.-F.; Wu, C.-C.; Chen, M.-H.; Su, W.-F. A Novel Polyurethane/Cellulose Fibrous Scaffold for Cardiac Tissue Engineering. RSC Advances 2014, 5 (9), 6932-6939, DOI: 10.1039/C4RA12486C
[23]. Hwang, J.-Y.; Kuo, C.-C.; Chen, L.-C.; Chen, K.-H. Correlating Defect Density with Carrier Mobility in Large-Scaled Graphene Films: Raman Spectral Signatures for the Estimation of Defect Density. Nanotechnology 2010, 21 (46), 465705, DOI: 10.1088/0957-4484/21/46/465705
[24]. Shi, Y.; Xiong, D.; Li, J.; Wang, K.; Wang, N. In Situ Repair of Graphene Defects and Enhancement of Its Reinforcement Effect in Polyvinyl Alcohol Hydrogels. RSC Advances 2017, 7 (2), 1045-1055, DOI: 10.1039/C6RA24949C
[25]. Kim, K.; Nam, K.-H.; Lee, J.; Kim, H.-J.; Goh, M.; Ku, B.-C.; You, N.-H. Effect of Defect-Healing in Graphene Nanosheets on the Mechanical Properties of Polyimide Nanocomposites. Carbon 2017, 122, 614-621, DOI: 10.1016/j.carbon.2017.06.102
[26]. Rosu, D.; Rosu, L.; Cascaval, C. N. IR-Change and Yellowing of Polyurethane as a Result of UV Irradiation. Polymer Degradation and Stability 2009, 94 (4), 591-596, DOI: 10.1016/j.polymdegradstab 0.2009.01.013
[27]. Yong, Q.; Chang, J.; Liu, Q.; Jiang, F.; Wei, D.; Li, H. Matt Polyurethane Coating: Correlation of Surface Roughness on Measurement Length and Gloss. Polymers 2020, 12 (2), 326, DOI: 10.3390/polym12020326
[28]. Gent, A. N.; Mars, W. V. Strength of Elastomers. The Science and Technology of Rubber 2013, 473-516, DOI: 10.1016/B978-0-12-394584-6.00010-8
[29]. Liao, L.; Xiao, W.; Zhao, M.; Yu, X.; Wang, H.; Wang, Q.; Chu, S.; Cui, Y. Can N95 Respirators Be Reused after Disinfection? How Many Times? ACS Nano 2020, 14 (5), 6348-6356, DOI: 10.1021/acsnano.0c03597
[30]. Price, A.; Cui, Y.; Liao, L.; Xiao, W.; Yu, X.; Wang, H.; Zhao, M.; Wang, Q.; Chu, S.; Chu, L. Preprint: Is the Fit of N95 Facial Masks Effected by Disinfection? A Study of Heat and UV Disinfection Methods Using the OSHA Protocol Fit Test. medRxiv 2020, DOI: 10.1101/2020.04.14.20062810
[31]. Lin, Y.; Liu, S.; Chen, S.; Wei, Y.; Dong, X.; Liu, L. A Highly Stretchable and Sensitive Strain Sensor Based on Graphene-Elastomer Composites with a Novel Double-Interconnected Network. Journal of Materials Chemistry C 2016, 4 (26), 6345-6352, DOI: 10.1039/C6TC01925K
[32]. Fan, W.; Wang, J.; Zhang, Z.; Li, Z. Synergistic Enhancement of UV-Resistance and Electrical Conductivity of Waterborne Polyurethane Composite with Combination of Functionalized 2D Graphene Oxide and 1D Nanocellulose. Progress in Organic Coatings 2021, 151, 106017, DOI: 10.1016/j.porgcoat.2020.106017
[33]. Murariu, A. C.; Macarie, L.; Crisan, L.; Pleu, N. Experimental Investigations of ALMG3 Components with Polyurethane and Graphene Oxide Nanosheets Composite Coatings, after Accelerated UV-Aging. Molecules 2021, 27 (1), 84, DOI: 10.3390/molecules27010084
[34]. Khan, U.; May, P.; O'Neill, A.; Coleman, J. N. Development of Stiff, Strong, Yet Tough Composites by the Addition of Solvent Exfoliated Graphene to Polyurethane. Carbon 2010, 48 (14), 4035-4041, DOI: 10.1016/j.carbon.2010.07.008
[35]. Wan, C.; Jiao, Y.; Li, J. In Situ Deposition of Graphene Nanosheets on Wood Surface by One-Pot Hydrothermal Method for Enhanced UV-Resistant Ability. Applied Surface Science 2015, 347, 891-897, DOI: 10.1016/j.apsusc.2015.04.178
[36]. Seyed Shahabadi, S. I.; Kong, J.; Lu, X. Aqueous-Only, Green Route to Self-Healable, UV-Resistant, and Electrically Conductive Polyurethane/Graphene/Lignin Nanocomposite Coatings. ACS Sustainable Chemistry & Engineering 2017, 5 (4), 3148-3157, DOI: 10.1021/acssuschemeng.6b02941
[37]. Bramhecha, I.; Sheikh, J. Antibacterial and Waterproof Breathable Waterborne Polyurethane Functionalised by Graphene to Develop UV and Nir-Protective Cotton Fabric. Carbon Trends 2021, 4, 100067, DOI: 10.1016/j.cartre.2021.100067
[38]. Adak, B.; Joshi, M.; Butola, B. S. Polyurethane/Functionalized-Graphene Nanocomposite Films with Enhanced Weather Resistance and Gas Barrier Properties. Composites Part B: Engineering 2019, 176, 107303, DOI: 10.1016/j.compositesb.2019.107303
[39]. Kong G. et al., Three-dimensional porous graphene/polyurethane flexible stress-strain sensor and preparation method thereof, Chinese Patent Application Publication No. CN112374490A, Feb. 19, 2021.
[40]. Huang, H. et al., Novel water-based graphene polyurethane coating, Chinese Patent Application Publication No. CN111944410A, Nov. 17, 2020.
[41]. Liu, D. et al., Preparation method of graphene modified polyurethane composite material, Chinese Patent Application Publication No. CN111647263A, Sep. 11, 2020.
[42]. Qiu, L. et al., Preparation method of ultraviolet-proof antistatic graphene coating textile fabric, Chinese Patent No. CN103469555B, Apr. 22, 2015.
[43]. Hersam, M. C. et al., Methods for preparation of concentrated graphene ink compositions and related composite materials, U.S. Pat. No. 10,676,629 B2, Jun. 9, 2020.

What is claimed is:

1. A composite, comprising:
an elastomeric matrix comprising at least one elastomer; and
an UV-resistant additive incorporated into the elastomeric matrix.

2. The composite of claim 1, wherein the at least one elastomer comprises polyurethane, polyisoprene, polypropylene, and/or polybutadiene.

3. The composite of claim 1, wherein the UV-resistant additive is adapted for absorbing UV light, thereby suppressing UV-induced degradation of the elastomeric matrix.

4. The composite of claim 3, wherein the UV-resistant additive comprises graphene.

5. The composite of claim 4, wherein the graphene comprises solution-exfoliated graphene.

6. The composite of claim 4, wherein a concentration of the graphene is up to 2 wt % of the composite.

7. The composite of claim 6, wherein the concentration of the graphene is 1 wt % of the composite.

8. The composite of claim 6, wherein increasing the concentration of the graphene in the composite improves mechanical strength and toughness of the composite.

9. The composite of claim 4, wherein the UV-resistant additive further comprises a cellulose polymer for providing a mechanical reinforcement to the elastomeric matrix.

10. The composite of claim 9, wherein the cellulose polymer comprises ethyl cellulose (EC), nitrocellulose and/or cellulose nanocrystals.

11. The composite of claim 10, wherein the graphene/EC powder is adapted to increase Young's modulus, elongation at break, and toughness, with negligible changes following UV exposure.

12. The composite of claim 11, wherein Raman spectroscopy signals for the characteristic graphene peaks comprise D, G, and 2D peaks at 1342 cm⁻¹, 1578 cm⁻¹, and 2700 cm⁻¹, respectively, which are consistent with that of the graphene/EC powder, suggesting that the graphene remain intact following the composite formulation.

13. The composite of claim 12, wherein the D/G peak ratio remains less than 1 in the composite, which confirms a relatively low graphene defect density compared to other graphene-based elastomeric composites that employ highly defective graphene oxide or reduced graphene oxide.

14. The composite of claim 1, wherein the composites remain mechanically robust over at least 150 sterilization cycles, enabling safe reuse following ultraviolet germicidal irradiation (UVGI).

15. The composite of claim 1, being UV and weathering resistant.

16. The composite of claim 1, being a free-standing composite.

17. The composite of claim 1, being fabricated by in-situ polymerization.

18. Personal protective equipment (PPE), comprising at least one component formed of the composite of claim 1.

19. The PPE of claim 18, wherein the at least one component is mask straps, or gloves, medical gowns, medical bouffant caps, and/or related protective coverings.

20. A method of fabricating a composite, comprising:
providing an elastomeric matrix and an UV-resistant additive; and
mechanically mixing the UV-resistant additive with the elastomeric matrix.

21. The method of claim 20, wherein the elastomeric matrix comprises an elastomer kit including a crosslinker and a mix of elastomer polyols.

22. The method of claim 21, wherein said mixing step comprises:
mixing various amounts of the UV-resistant additive with the elastomer polyols by bath sonicating and subsequently using a centrifugal mixer to form a first mixture thereof; and
adding the crosslinker into the first mixture to form a second mixture in which a weight ratio of the crosslinker to the elastomer polyols is about 1:1;
curing the second mixture at room temperature to form the composite.

23. The method of claim 22, further comprising thermally treating the composite at a temperature for a period of time to further improve mechanical properties.

24. The method of claim 23, wherein the temperature is in a range of about 50-100° C., and the period of time is in a range of about 5-12 hrs.

25. The method of claim 21, wherein the elastomer comprises polyurethane,polyisoprene, polypropylene, and/or polybutadiene.

26. The method of claim 20, wherein the UV-resistant additive is adapted for absorbing UV light, thereby suppressing UV-induced degradation of the elastomeric matrix.

27. The method of claim 26, wherein the UV-resistant additive comprises graphene.

28. The method of claim 27, wherein the graphene comprises solution-exfoliated graphene.

29. The method of claim 27, wherein a concentration of the graphene is up to 2 wt % of the composite.

30. The method of claim 29, wherein the concentration of the graphene is 1 wt % of the composite.

31. The method of claim 27, wherein the UV-resistant additive further comprises a cellulose polymer for providing a mechanical reinforcement to the elastomeric matrix.

32. The method of claim 31, wherein the cellulose polymer comprises ethyl cellulose (EC), nitrocellulose and/or cellulose nanocrystals.
